(19) United States
(12) Patent Application Publication
(10) Pub. No.: US 2007/0142008 A1
(43) Pub. Date: Jun. 21, 2007

(54) System and method for receiving and processing telemetry

(75) Inventor: Edward James Bedenko, Sarasota, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/305,523

(22) Filed: Dec. 16, 2005

(51) Int. Cl. G06F 3/033

(52) U.S. Cl. 455/130; 455/39

(57) ABSTRACT

A system and method for receiving and processing telemetry data are disclosed, which translates received telemetry data into a high performance, universal serial bus format that significantly broadens the range of telemetry hardware that can be used. For example, a system for receiving and processing telemetry data is disclosed, which includes a receiver unit that receives and demodulates a down-linked telemetry signal and produces a broadband video signal including the received telemetry data, a processing unit that translates the telemetry data in the broadband video signal to an IEEE1394 serial bus format, and distributes the data in IEEE1394 packet form to other devices in or external to the system involved. Thus, the processing unit of the system can interface with substantially any IEEE1394-compatible device, via Fiber Optics or other suitable media, which significantly increases the range and interoperability of the telemetry hardware that can be used.

### FIELD OF THE INVENTION

The present invention relates generally to the data communications and processing field, and more specifically, but not exclusively, to an improved system and method for receiving and processing telemetry.

### BACKGROUND OF THE INVENTION

Telemetry is a technology used to gather data at a distant location, and convey the gathered data in a down-linked data stream to a remote station for recording and analysis. For example, telemetry data can include measured physical, environmental or biological data. As such, the term “telemetry” also refers to the signals containing the gathered data. Typically, telemetry is used to collect data (including medical data) from measurement instrumentation located in manned and unmanned spacecraft, launch vehicles, satellites, space probes, and space-based robotic vehicles, and transmit the gathered data to stations on the ground. Telemetry data can also be gathered and down-linked from aircraft, sea-based and land-based vehicles, or fixed stations located on the ground (e.g., relayed by one or more repeaters).

Notwithstanding the numerous advantages of today's telemetry systems, a significant problem has arisen with respect to processing the telemetry data received. For example, each system used to receive and process telemetry down-linked from spacecraft, launch vehicles, airborne test systems, and similar other platforms typically uses unique (often proprietary) processing software, which is not easily integrated with other systems' hardware and software solutions that can be used. In addition, processing equipment is frequently separated from the acquisition equipment by some distance. Consequently, today's telemetry systems are limited significantly because of the lack of interoperability of the different hardware that can be used. Therefore, it would be advantageous to have a system and method that allows a broader range of equipment interoperability and high-speed data transfer between receiving and processing components, than existing telemetry systems provide. As described in detail below, the present invention provides such a system and method, which resolves the telemetry hardware interoperability problem and similar other problems.

### SUMMARY OF THE INVENTION

The present invention provides a system and method for receiving and processing telemetry data, which translates received telemetry data into a high performance, universal serial bus format that significantly broadens the range of telemetry hardware that can be used, as well as permitting physical dislocation of receiving and processing equipment. In accordance with a preferred embodiment of the present invention, a system is provided for receiving and processing telemetry data, which includes a receiver unit that receives and demodulates a down-linked telemetry signal and produces a broadband video signal including the received telemetry data, a processing unit that translates the telemetry data in the broadband video signal to an IEEE1394 serial bus format, and distributes the data in IEEE1394 packet form, over fiber optics or other suitable media permitted by the IEEE 1394 standard, to other devices in or external to the system involved. Thus, the processing unit of the system can interface with substantially any IEEE1394-compatible device, which significantly increases the range and interoperability of the telemetry hardware that can be used.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawing(s), wherein:

FIG. 1 depicts a block diagram of an example system for receiving and processing telemetry, which can be used to implement a preferred embodiment of the present invention.

### DETAILED DESCRIPTION OF PREFERRED EMBODIMENT

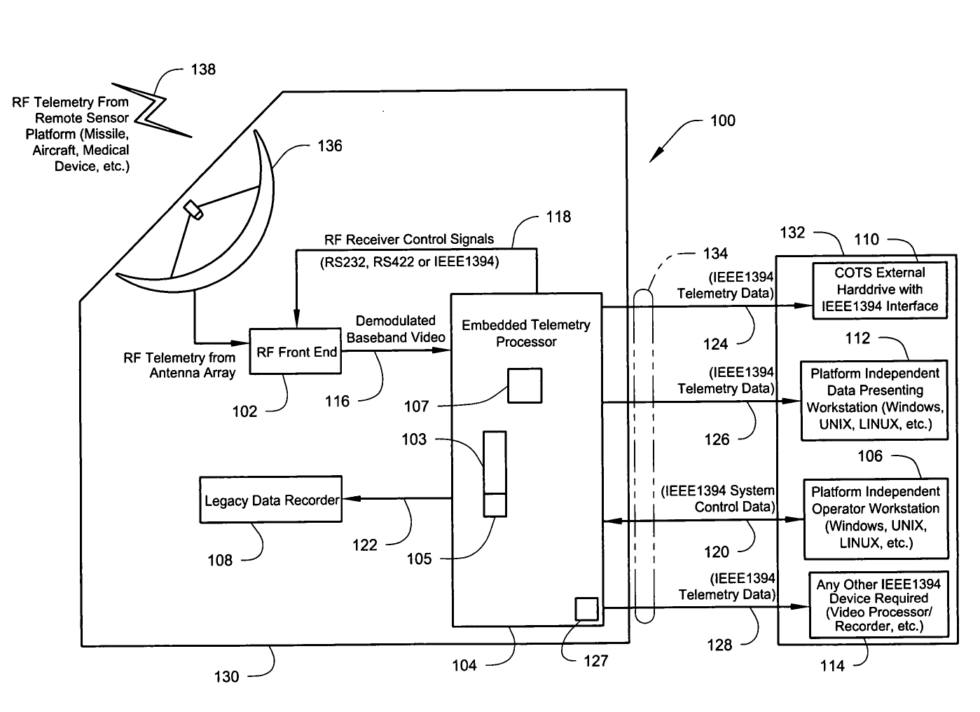

With reference now to the figures, FIG. 1 depicts a block diagram of an example system 100 for receiving and processing telemetry, including a remote Antenna Subsystem 130 and an Operations Site 132, which can be used to implement a preferred embodiment of the present invention. The Antenna Subsystem 130 and Operations Site 132 can be dislocated or separated by a significant distance. For this example embodiment, system 100 includes a receiver unit 102. Receiver unit 102 receives a Radio Frequency (RF) signal 138 including telemetry data from a receive Antenna Array 136, detects and pre-amplifies the RF signal, down-converts the RF signal to an Intermediate Frequency (IF) signal, and demodulates the IF signal to produce a baseband video signal including the received telemetry data. For example, the receive Antenna Subsystem 130 can be configured to receive telemetry signals in the S-band of frequencies, and receiver unit 102 can be selectively tuned to receive RF telemetry signals at 2.2 GHz. At this point, it should be understood that the specific configuration and operating frequencies disclosed herein for example receiver unit 102 are not to be considered as architectural limitations to be imposed on the scope and coverage of the present invention. Any suitable receiver front end that can receive signals including telemetry data, and convert the received signals to baseband video signals including the telemetry data, can be used to implement receiver unit 102.

For this example embodiment, system 100 also includes a telemetry processing unit 104. Essentially, telemetry processing unit 104 receives the baseband video signals (including the telemetry data) from receiver unit 102 (e.g., via video cable 116), a front end unit 103 of processing unit 104 detects and extracts the telemetry data from the incoming baseband video signals, and an analog-to-digital (A/D) converter unit 106 converts the analog telemetry data to digital form (e.g., serial digital data). Processing unit 104 also includes a digital processor 107. For example, digital processor 107 can be a computer processor such as, for example, a microprocessor, digital signal processor, microcontroller, embedded processor, or a processor based on a PowerPC® processing architecture. Preferably, for this embodiment, digital processor 107 is implemented with one or more PowerPC embedded microcontrollers, or with one or more embedded processors running with a PowerPC-based Operating System (OS). As such, digital processor 107 can be arranged as a single processor or plurality of processors connected to a data communications bus or system bus. A memory controller/cache can also be connected to the data communications bus or system bus, which can provide an interface between digital processor 107 and a local memory (e.g., RAM, ROM, etc.). A plurality of machine instructions can be stored in the local memory and retrieved and operated on by digital processor 107 to generate, for example, the control signals used for selectively tuning the receive frequency of receiver unit 102 (e.g., conveyed via control link 118). An Input/Output (I/O) bus bridge can also be connected to the data communications bus or system bus, which can provide an interface between digital processor 107 and an I/O bus. Thus, digital processor 107 can receive, retrieve and/or send data via such an I/O bus. In any event, those of ordinary skill in the art will appreciate that the hardware described herein for digital processor 107 in FIG. 1 may vary. As such, the depicted example is provided for illustrative purposes and not meant to imply any architectural limitations with respect to the present invention.

For this example embodiment, a primary function of digital processor 107 is to translate the telemetry data coupled from A/D converter unit 105 (serial digital data) to telemetry data in an IEEE 1394 format, and output the IEEE 1394-formatted telemetry data (e.g., via an I/O bus of processing unit 104 and Fiber Optic Cable 134) to the Operations Site 132, which contains a plurality of IEEE-compatible devices that can be used to store, record and/or analyze the telemetry data. For example, processing unit 104 can provide received telemetry data in an IEEE 1394 packet (message) format (via IEEE 1394 data link 124 and via Fiber Optic Cable 134 or other suitable medium) to a commercially available, off-the-shelf external hard-drive 110 (e.g., via an IEEE 1394 interface of the hard drive) for storage, to a platform-independent workstation 112 (via IEEE 1394 data link 126) for data presentation to a user via a monitor (e.g., using a Windows, UNIX, LINUX, etc. OS), or to any other IEEE 1394-compatible device (e.g., peripheral device, camcorder, VCR, printer, PC, TV, digital camera, etc.) available (e.g., via IEEE 1394 data link 128) to perform the appropriate storing, recording, and/or analyzing functions involved. Also, processing unit 104 can provide legacy synchronous data (e.g., clock, data, etc.), which is extracted from the received telemetry signal, to a legacy data recorder 108 (via data link 122). In any event, if digital processor 107 provides received telemetry data in IEEE 1394 packet form to an IEEE 1394 I/O port (e.g., IEEE 1394 I/O port 127), then that port can be used to connect digital processor 107 with up to 64 IEEE 1394-compatible devices.

For this example embodiment, system 100 also includes an operator control workstation 106 typically located at the Operations Site 132. For example, operator control workstation 106 can be used by a user/operator to provide input commands/instructions or control commands to digital processor 107 (e.g., via an IEEE 1394 data bus 120). Therefore, using workstation 106, an operator can control the operations of system 100 and its components, which includes the operations of receiver unit 102 (e.g., tuning, demodulation, etc.), processing unit 104, and/or digital processor 107 itself. As such, operator control workstation 106 can be implemented with any suitable workstation that is platform independent and includes an OS that supports IEEE 1394 operations (e.g., Windows, UNIX, LINUX, etc.).

It is important to note that while the present invention has been described in the context of a fully functioning system for receiving and processing telemetry, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular system for receiving and processing telemetry.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A system for receiving and processing telemetry data, comprising:
a receiver unit, said receiver unit operable to:
receive a modulated signal including telemetry data, demodulate said modulated signal, and generate a baseband signal including said telemetry data; and
a processing unit coupled to said receiver unit, said processing unit operable to:
receive said baseband signal including said telemetry data;
extract said telemetry data from said baseband signal; and
translate said telemetry data from a first data format to a second data format, said second data format associated with a universal serial data protocol.

2. The system of claim 1, wherein said universal serial data protocol comprises an IEEE 1394 protocol.

3. The system of claim 1, wherein said modulated signal comprises an RF telemetry signal.

4. The system of claim 1, wherein said baseband signal comprises a baseband video signal.

5. The system of claim 1, wherein said processing unit comprises at least one of a base band video detector, an analog-to-digital converter, and a digital processor.

6. The system of claim 1, further comprising:
a plurality of telemetry devices coupled to an output of said processing unit, wherein each telemetry device of said plurality of telemetry devices is an IEEE 1394-compatible device.

7. The system of claim 1, further comprising:
a platform independent operator workstation coupled to said processing unit, said platform independent operator workstation operable to convey a plurality of control commands to said processing unit.

8. The system of claim 1, wherein said processing unit includes an embedded processor.

9. The system of claim 1, wherein said processing unit includes a PowerPC embedded processor.

10. The system of claim 1, wherein said processing unit includes a digital processor, and an output of said digital processor is coupled to an IEEE 1394 I/O port.

11. The system of claim 1, wherein said modulated signal comprises a PCM signal.

12. A telemetry processing system, comprising:
means for receiving a modulated signal including telemetry data;
means for demodulating said modulated signal;
means for generating a baseband signal including said telemetry data;
means for extracting said telemetry data from said baseband signal; and
means for translating said telemetry data from a first data format to a second data format, said second data format associated with a universal serial data protocol.

13. The telemetry processing system of claim 12, further comprising:
data processing means; and
means for conveying a plurality of control commands to said data processing means.

14. A method for receiving and processing telemetry data, comprising:
receiving a modulated signal including telemetry data;
demodulating said modulated signal;
generating a baseband signal including said telemetry data;
extracting said telemetry data from said baseband signal; and
translating said telemetry data from a first data format to a second data format, said second data format associated with a universal serial data protocol.

15. The method of claim 14, wherein said universal serial data protocol comprises an IEEE 1394 protocol.

16. The method of claim 14, wherein said universal serial data protocol utilizes at least a Fiber Optic medium to interconnect a plurality of components.

17. The method of claim 14, wherein said modulated signal comprises an RF telemetry signal.

18. The method of claim 14, wherein said baseband signal comprises a baseband video signal.

19. The method of claim 14, wherein the extracting and translating steps are performed by a video detector, an analog-to-digital converter, and a digital processor.

20. The method of claim 14, further comprising the steps of:
coupling a plurality of telemetry devices to an output, wherein each telemetry device of said plurality of telemetry devices is an IEEE 1394-compatible device.

21. A computer program product, comprising:
a computer-usable medium having computer-readable code embodied therein for configuring a computer processor, the computer program product comprising:
a first executable computer-readable code configured to cause a computer processor to receive a modulated signal including telemetry data;
a second executable computer-readable code configured to cause a computer processor to demodulate said modulated signal;
a third executable computer-readable code configured to cause a computer processor to generate a baseband signal including said telemetry data;
a fourth executable computer-readable code configured to cause a computer processor to extract said telemetry data from said baseband signal; and
a fifth executable computer-readable code configured to cause a computer processor to translate said telemetry data from a first data format to a second data format, said second data format associated with an IEEE 1394 data protocol.
